(19) United States
(12) Patent Application Publication
(10) Pub. No.: US 2026/0312199 A1
(43) Pub. Date: Oct. 8, 2026

(54) ENERGY SAVING MODULE AND ENERGY SAVING SYSTEM INCLUDING THE SAME

(71) Applicant: Samsung SDI Co, Ltd., Yongin-si (KR)

(72) Inventor: Jae Seung Kim, Suwon-si (KR)

(73) Assignee: Samsung SDI Co, Ltd., Yongin-si (KR)

(21) Appl. No.: 19/629,500

(22) Filed: Mar. 26, 2026

(30) Foreign Application Priority Data
Apr. 4, 2025 (KR) 10-2025-0044061

(51) Int. Cl. H01M 50/24; A62C 2/06; H01M 50/209; H01M 50/271; H01M 50/30; H01M 50/358

(52) U.S. Cl. CPC H01M 50/24; A62C 2/06; H01M 50/209; H01M 50/271; H01M 50/358; H01M 50/394

(57) ABSTRACT

Provided are an energy storage module and an energy saving system including the same. The energy storage module according to embodiments includes a plurality of secondary batteries, a module case that accommodates the plurality of secondary batteries therein and has an open upper side, a top plate coupled to an upper side of the module case and provided with a duct at a position corresponding to a vent of the secondary battery, an upper cover coupled to an upper side of the top plate and provided with a first opening at a position corresponding to the duct, and a fire extinguishing sheet, which is disposed between the top plate and the upper cover and provided with a second opening at a position corresponding to the duct, and accommodates a fire extinguishing agent therein, wherein the fire extinguishing sheet may include a flat plate portion provided with a plurality of second openings and a protrusion protruding from the flat plate portion in a direction toward the top plate.

### CROSS-REFERENCE TO RELATED APPLICATION

This present application claims priority to and the benefit under 35 U.S.C. § 119(a)-(d) of Korean Patent Application No. 10-2025-0044061, filed on Apr. 4, 2025, in the Korean Intellectual Property Office, the entire disclosure of which is incorporated herein by reference.

### FIELD

The present disclosure relates a secondary battery, and more specifically, to an energy storage module including a plurality of secondary batteries and an energy saving system including a plurality of energy storage modules.

### BACKGROUND

Secondary batteries are batteries that can be charged and discharged, unlike primary batteries that cannot be recharged. Low-capacity secondary batteries are used in small portable electronic devices such as smartphones, feature phones, notebook computers, digital cameras, and camcorders, and high-capacity secondary batteries are widely used as power sources for driving motors in hybrid vehicles, electric vehicles, and the like and as batteries for energy storage systems (ESSs).

An energy saving system is a system that can store surplus electricity or electricity produced using renewable energy and includes an energy storage module including a plurality of secondary batteries. The energy storage module may be configured by assembling a plurality of electrically interconnected secondary batteries in various structures. Also, the energy saving system is generally configured such that a plurality of energy storage modules are mounted and fixed on a rack, and one or more racks may be accommodated in a cabinet or container, or disposed indoors in a building.

Recently, the number of fire incidents in energy storage modules has been increasing. Due to the characteristics of the secondary batteries that make up the energy storage modules, it is difficult to extinguish a fire once it occurs. As energy storage modules are required to meet the demands for higher capacity and output, the capacity of individual secondary batteries is increasing, and as is the number of secondary batteries included therein. Accordingly, technologies for enhancing fire safety are increasingly required.

The herein-described information disclosed in the background technology of this disclosure is only intended to improve understanding of the background of the present disclosure and therefore may include information that does not constitute related art.

### SUMMARY

The present disclosure is directed to providing an energy storage module, which capable of suppressing the spread of thermal runaway from one secondary battery to adjacent secondary batteries even when a thermal runaway phenomenon occurs in any one of the secondary batteries, and an energy saving system including the same.

However, technical problems to be solved by the present disclosure are not limited to the problems described herein, and other problems that are not described may be clearly understood by those skilled in the art from the description of the disclosure described herein.

An energy storage module according to embodiments of the present disclosure includes a plurality of secondary batteries, a module case that accommodates the plurality of secondary batteries therein and has an open upper side, a top plate coupled to an upper side of the module case and provided with a duct at a position corresponding to a vent of the secondary battery, an upper cover coupled to an upper side of the top plate and provided with a first opening at a position corresponding to the duct, and a fire extinguishing sheet, which is disposed between the top plate and the upper cover and provided with a second opening at a position corresponding to the duct, and accommodates a fire extinguishing agent therein, wherein the fire extinguishing sheet may include a flat plate portion provided with a plurality of second openings and a protrusion protruding from the flat plate portion in a direction toward the top plate.

According to aspects of the embodiments, the protrusion may protrude from the flat plate portion around the second opening.

According to aspects of the embodiments, a plurality of protrusions may be spaced apart from one another and disposed between adjacent second openings.

Also, the flat plate portion may have a shape extending in a first direction, which is an arrangement direction of the secondary battery and the protrusion may have a plate shape extending in a second direction that intersects the first direction. In this case, the plurality of protrusions disposed between the adjacent second openings may be arranged substantially in the first direction.

According to aspects of the embodiments, the flat plate portion and the protrusion may be integrally formed. Also, in the fire extinguishing sheet, a plurality of capsules containing the fire extinguishing agent may be dispersed in a base member made of polyurea or polyurethane.

An energy saving system according to embodiments of the present disclosure includes a rack on which a plurality of energy storage modules are mounted, wherein the energy storage module includes a plurality of secondary batteries, a module case that accommodates the plurality of secondary batteries therein and has an open upper side, a top plate coupled to an upper side of the module case and provided with a duct at a position corresponding to a vent of the secondary battery, an upper cover coupled to an upper side of the top plate and provided with a first opening at a position corresponding to the duct, and a fire extinguishing sheet, which is disposed between the top plate and the upper cover and provided with a second opening at a position corresponding to the duct, and accommodates a fire extinguishing agent therein, wherein the fire extinguishing sheet may include a flat plate portion provided with a plurality of second openings and a protrusion protruding from the flat plate portion in a direction toward the top plate.

### BRIEF DESCRIPTION OF THE DRAWINGS

The following drawings attached to the present specification illustrate exemplary embodiments of the present disclosure and further describe aspects and features of the present disclosure together with the detailed description of the present disclosure. Thus, the present disclosure should not be construed as being limited to the drawings, in which:

FIG. 1 is a perspective view schematically illustrating an example of an energy saving system according to embodiments of the present disclosure;

FIG. 2 is a perspective view illustrating an example of an energy storage module according to embodiments of the present disclosure;

FIG. 3 is an enlarged view of part III in FIG. 2;

FIG. 4 is an exploded perspective view illustrating the energy storage module in FIG. 2;

FIG. 5 is a perspective view illustrating a plurality of secondary batteries disposed inside a module case in FIG. 4;

FIG. 6 is a cross-sectional view along line VI-VI in FIG. 3;

FIG. 7 is a cross-sectional view along line VII-VII in FIG. 3;

FIG. 8 is a perspective view illustrating a fire extinguishing sheet according to embodiments; and

FIG. 9 is a view schematically illustrating a configuration of the fire extinguishing sheet in FIG. 8.

### DETAILED DESCRIPTION

Hereinafter, exemplary embodiments of the present disclosure will be described in detail with reference to the attached drawings. Prior to this, terms or words used in this specification and claims should not be interpreted limited to ordinary or dictionary meanings and should be interpreted as meanings and concepts consistent with the technical idea of this disclosure based on the principle that the inventor can properly define the concept of the term in order to describe his or her disclosure in the best way. Accordingly, it is to be understood that the embodiments described herein, and the configurations illustrated in the drawings are only some of the most exemplary embodiments of the disclosure and do not represent all of the technical ideas of the disclosure, and that there may be various equivalents and modifications that may replace them at the time of filing.

Furthermore, when used herein, the terms “comprise or include” and/or “comprising or including” specify the presence of the described shapes, numbers, steps, operations, members, elements, and/or groups thereof and are not intended to exclude the presence or addition of one or more other shapes, numbers, operations, members, elements, and/or groups thereof.

In addition, in order to help understand the disclosure, the attached drawings are not drawn to actual scale, and the dimensions of some components may be exaggerated. In addition, the same reference numbers may be assigned to the same components in different embodiments.

The statement that two objects for comparison are “equal” means “substantially the same.” Therefore, substantially the same may include deviations that are considered low in the art, for example, deviations of less than 5%. Additionally, uniformity of a parameter over a given region may mean uniformity from an average perspective.

Although first, second, and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary component is disposed “on (or under)” a first component or “above (or below)” the first component, it can mean not only that the arbitrary component is disposed in contact with the top (or bottom) of the first component, but also that a second component can be interposed between the first component and the arbitrary component disposed on (or under) the first component.

Further, when it is disclosed that a certain component is “connected,” “coupled,” or “linked” to another component, it should be understood that the components may be directly connected or linked to one another, but another component may be “interposed” between the components, or the components may be “connected,” “coupled,” or “linked” through another component. In addition, when a portion is “electrically coupled” to another part, this includes not only the case where it is “directly connected” but also the case where it is “connected” with another member or element interposed therebetween.

Throughout the specification, “A and/or B” means A, B, or A and B unless otherwise stated to the contrary, That is, “and/or” includes any or all combinations of a plurality of listed items. When “C to D” is stated, it means greater than or equal to C and less than or equal to D unless otherwise specifically stated.

In the present specification, “a combinations thereof” may mean a mixture, a laminate, a composite, a copolymer, an alloy, a blend, and a reaction product of components.

The terms used in the present specification are intended to describe the embodiments of the present disclosure, and are not intended to limit the present disclosure.

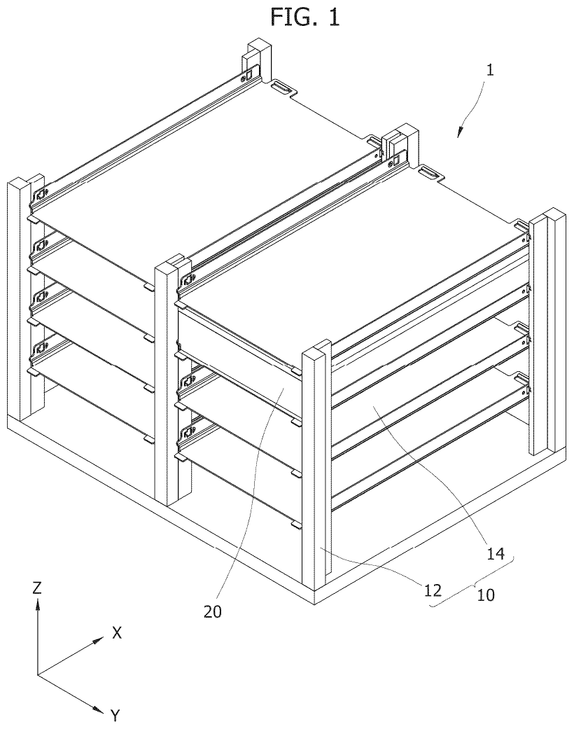

FIG. 1 is a perspective view schematically illustrating an example of an energy saving system according to embodiments of the present disclosure. Referring to FIG. 1, an energy saving system 1 includes a rack 10 and an energy storage module 20. In FIG. 1, only one energy storage module 20 is illustrated as being mounted on a single rack 10, which is merely for convenience of illustration. Typically, the energy saving system 1 includes one or more racks 10 and each rack 10 may have a plurality of energy storage modules 20 mounted thereon.

The rack 10 provides a space in which the energy storage module 20 may be mounted inside and/or on top. The rack 10 may include a rack frame 12 and a rack shelf 14. In FIG. 1, the rack 10 is illustrated as having two columns in a Y-axis direction and four tiers in a Z-axis direction, but this is merely exemplary. The overall structure of the rack 10 may vary depending on the number of energy storage modules 20 included in the energy saving system 1.

The rack frame 12 may form the overall exterior of the rack 10 and have the form of a hollow box or frame. The rack frame 12 may include a plate-shaped base parallel to the XY plane and a column-shaped support member installed to extend from the base in the Z-axis direction, as illustrated in FIG. 1.

The rack frame 12 may be disposed indoors in a building, or inside a container, cabinet, or the like. The rack frame 12, especially the support member, may be formed of a high-strength material such as steel to prevent damage due to the load applied by a battery module 20. The shape of the space defined by the rack frame 12 may be designed to have various shapes, such as a polyhedron or cylinder, in addition to the rectangular parallelepiped shape illustrated in FIG. 1.

The rack shelf 14 is a flat plate-shaped member installed parallel to the XY plane within the rack frame 12, and is a structure that supports the energy storage module 20 from below. In FIG. 1, eight rack shelves 14 are illustrated as being installed in two columns and four tiers, but this is merely exemplary. The number of columns and/or tiers of the rack shelves 14 installed within the rack frame 12 may vary depending on the number of energy storage modules 20 included in the energy saving system 1 and the structure of the rack 10.

The shape of the rack shelf 14 may be implemented in various forms and is not particularly limited. For example, as illustrated in FIG. 1, the rack shelf 14 may be installed as a single flat plate between the support members of adjacent rack frames 12 to support the entire bottom surface of the energy storage module 20. Alternatively, the rack shelves 14 may be installed in pairs on both sides of the support members of adjacent rack frames 12 in the Y-axis direction to support both edges of the bottom surface of the energy storage module 20.

The energy storage module 20 may store power through charging and discharging operations or supply the stored power to an external electronic device (not shown). The energy storage module 20 may include a module case having a roughly box shape and a plurality of secondary batteries disposed inside the module case. Additionally, the energy storage module 20 may further include a fire extinguishing sheet for discharging a fire extinguishing agent in the event of thermal runaway of the secondary battery, which will be described herein. Additionally, the energy storage module 20 may further include a cooling member for cooling the secondary battery and/or an insulating member for electrical insulation between adjacent secondary batteries.

One or more energy storage modules 20 may be mounted on the rack shelf 14. For example, only one energy storage module 20 may be mounted on one rack shelf 14. However, the present disclosure is not limited thereto, and two or more energy storage modules 20 arranged in the X-axis direction may be mounted on one rack shelf 14.

Also, the energy storage modules 20 may be stacked vertically within the rack frame 12. A predetermined space may present between the vertically stacked energy storage modules 20, that is, between the energy storage module 20 and the rack shelf 14 located above the energy storage module 20. Also, the vertically stacked energy storage modules 20 may be disposed in a plurality of columns, such as one or two or more columns. That is, the plurality of energy storage modules 20 may be disposed in the plurality of columns in the Y-axis direction based on FIG. 1.

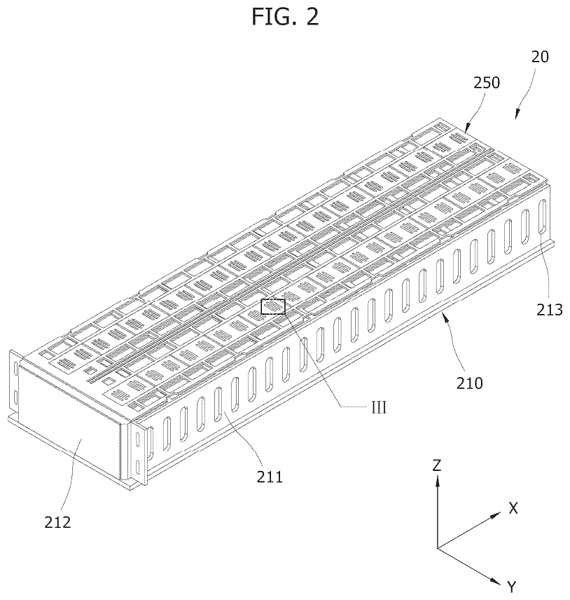

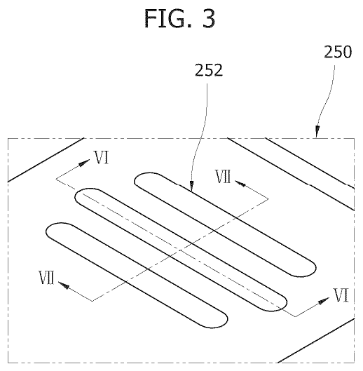

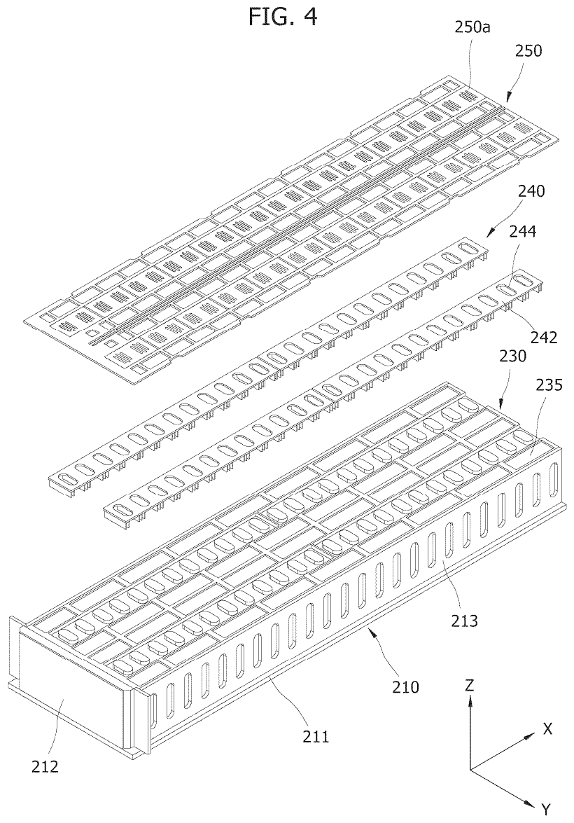

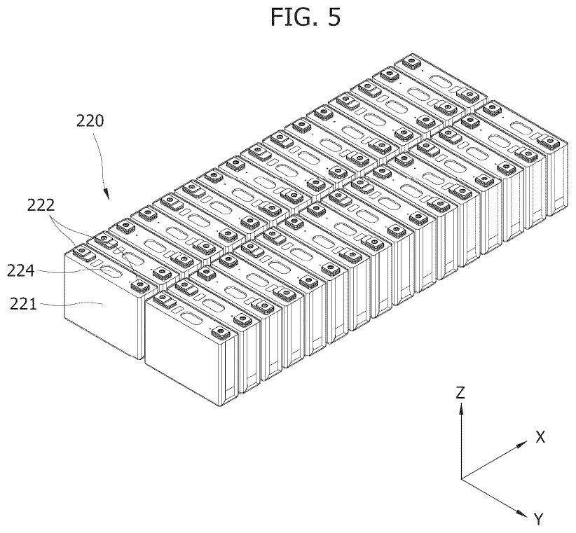

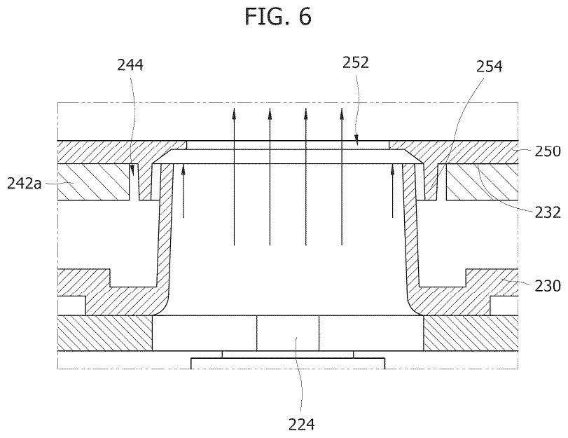

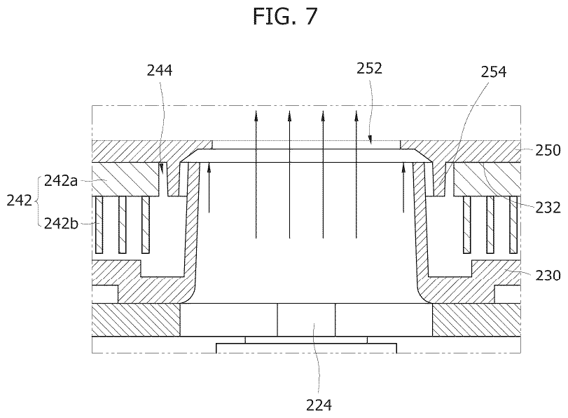

FIG. 2 is a perspective view illustrating an example of an energy storage module according to embodiments of the present disclosure. FIG. 3 is an enlarged view of part III in FIG. 2. FIG. 4 is an exploded perspective view illustrating the energy storage module in FIG. 2. FIG. 5 is a perspective view illustrating a plurality of secondary batteries disposed inside a module case in FIG. 4. FIG. 6 is a cross-sectional view along line VI-VI in FIG. 3. FIG. 7 is a cross-sectional view along line VII-VII in FIG. 3.

Referring to FIGS. 2 to 7, the energy storage module 20 includes a module case 210, a plurality of secondary batteries 220, a top plate 230, a fire extinguishing sheet 240, and an upper cover 250.

The module case 210 provides a space in which the plurality of secondary batteries 220 may be accommodated. The module case 210 may have an overall rectangular parallelepiped shape. The module case 210 may include a bottom plate 211, a pair of end plates 212, and a pair of side plates 213, and an upper side thereof may be open. The module case 210 may fix positions of the plurality of secondary batteries 220 and protect the plurality of secondary batteries 220 from external impacts or the like.

The secondary battery 220 may function as a unit structure that stores and supplies power in the secondary battery module 20. The plurality of secondary batteries 220 may be disposed inside the module case 210. The plurality of secondary batteries 220 may be arranged in various ways inside the module case 210.

For example, the plurality of secondary batteries 220 may be arranged in the X-axis direction. Additionally, one or more rows of secondary batteries 220 arranged in the X-axis direction may be provided. In FIG. 5, the plurality of secondary batteries 220 are illustrated as being arranged in two rows spaced apart at predetermined intervals in the Y-axis direction, but this is merely exemplary. Also, although not shown in the drawing, an insulating member may be further provided between the secondary batteries 220 arranged in the X-axis direction.

The plurality of secondary batteries 220 may be electrically connected as a whole. The plurality of secondary batteries 220 may be connected entirely in series or in parallel. Alternatively, the plurality of secondary batteries 220 may be interconnected in a combination of series and parallel connections. The plurality of secondary batteries 220 may be electrically connected via bus bars 235, which are electrically conductive connecting members.

The secondary battery 220 may include a case that accommodates an electrode assembly therein and has an open upper side, and a cap assembly that covers an upper side of the case. In the case of a prismatic secondary battery 220, the case may have an overall rectangular parallelepiped shape. In addition, the cap assembly may be coupled to the case and seal the case. The cap assembly may include a cap plate having a vent 224 and a pair of electrode terminals 222.

The electrode assembly of the secondary battery 220 may include a first electrode, a second electrode, and a separator. The separator may be disposed between the first electrode and the second electrode. The electrode assembly may have a stacked form including a plurality of stacks, each formed by sequentially stacking the first electrode, the separator, the second electrode, and the separator, but is not limited thereto.

The first electrode may function as a positive electrode of the electrode assembly. In this case, the first electrode may be formed in the form of a foil including a metallic material such as aluminum or an aluminum alloy. The type, size, and shape of the first electrode are not particularly limited as long as it is conductive and does not cause a chemical change in the secondary battery. A plurality of first electrodes may be provided, and the number of first electrodes may be designed to vary depending on the charging capacity of the secondary battery.

A first active material layer may be formed on at least a portion of the first electrode. The first active material layer may be formed on both surfaces of the first electrode, or alternatively, may be formed on only one surface of the first electrode. Since the first electrode functions as a positive electrode, the first active material layer may include a positive electrode active material.

As the positive electrode active material, a compound capable of reversible intercalation and deintercalation of lithium (lithiated intercalation compound) may be used. Specifically, one or more of composite oxides of lithium and a metal selected from cobalt, manganese, nickel, iron, and a combination thereof may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM) and include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may further include a positive electrode conductive material. The positive electrode conductive material is used to impart conductivity to the first active material layer, and any material that does not cause chemical changes and is electronically conductive may be used. Examples of the positive electrode conductive material may include carbon-based materials such as natural graphite, artificial graphite, carbon black, acetylene black, Ketjen black, carbon fibers, carbon nanofibers, or carbon nanotubes; metal-based materials in the form of metal powder or metal fibers containing copper, nickel, aluminum, and silver; conductive polymers such as polyphenylene derivatives; or mixtures thereof.

The first active material layer may further include a positive electrode binder. The positive electrode binder serves to attach particles constituting the positive electrode active material to one another well and also to attach the positive electrode active material to the first electrode well. Examples of the positive electrode binder include a non-aqueous binder, an aqueous binder, a dry binder, or a combination thereof.

The second electrode may function as a negative electrode of the electrode assembly. In this case, the second electrode may be formed to have the form of a foil including a metallic material such as copper, a copper alloy, nickel, or a nickel alloy. The type, size, and shape of the second electrode are not particularly limited as long as it does not cause chemical changes in the secondary battery and is conductive.

A second active material layer may be formed on at least a portion of the second electrode. The second active material layer may be formed on both surfaces of the second electrode, or alternatively, may be formed on only one surface of the second electrode.

Since the second electrode functions as a negative electrode, the second active material layer may include a negative electrode active material. The negative electrode active material may include a material capable of reversibly intercalating and deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. Examples of the crystalline carbon may include graphite such as amorphous, plate-shaped, flaky, spherical, or fibrous natural graphite or artificial graphite, and examples of the amorphous carbon may include soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al and Sn may be used as the alloy of lithium and a metal.

As the material capable of doping and dedoping lithium, a Si-based negative electrode active material or Sn-based negative electrode active material may be used. The Si-based negative electrode active material may include silicon, a silicon-carbon composite, SiOₓ (0<x<2), a Si-Q alloy (where Q is selected from alkali metals, alkaline earth metals, group 13 elements, group 14 elements (excluding Si), group 15 elements, group 16 elements, transition metals, rare earth elements, and a combination thereof), or a combination thereof. The Sn-based negative electrode active material may include Sn, SnO₂, a Sn-based alloy, or a combination thereof.

The silicon-carbon composite may be a composite of silicon and amorphous carbon. According to embodiments, the silicon-carbon composite may be in the form of silicon particles whose surfaces are coated with amorphous carbon. For example, the silicon-carbon composite may include a secondary particle (a core) in which silicon primary particles are assembled and an amorphous carbon coating layer (a shell) located on the surface of the secondary particle. The amorphous carbon may also be located between the silicon primary particles so that, for example, the silicon primary particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer located on a surface of the core.

The Si-based negative electrode active material or the Sn-based negative electrode active material may be used in combination with the carbon-based negative electrode active material.

The second active material layer may further include a negative electrode conductive material and a negative electrode binder. The negative electrode conductive material may be used to impart conductivity to the second active material layer, and any electronically conductive material that does not cause a chemical change may be used. Examples of the negative electrode conductive material may include a carbon-based material such as natural graphite, artificial graphite, carbon black, acetylene black, Ketjen black, carbon fibers, carbon nanofibers, and carbon nanotubes, a metal-based material in the form of a metal powder or metal fiber containing copper, nickel, aluminum, silver, etc., a conductive polymer such as a polyphenylene derivative, or a mixture thereof.

The negative electrode binder serves to attach particles constituting the negative electrode active material to one another well, and also to attach the negative electrode active material well to the second electrode. Examples of the negative electrode binder include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(metha)acrylonitrile, an ethylene propylene diene copolymer, polyvinylpyridine, chlorosulfonated polyethylene, latex, polyester resin, (metha)acrylic resin, phenolic resin, epoxy resin, polyvinyl alcohol, and a combination thereof.

When the aqueous binder is used as the negative electrode binder, a cellulose-based compound capable of imparting viscosity may be further included. This cellulose-based compound may be used by mixing one or more of carboxymethyl cellulose, hydroxypropyl methyl cellulose, methyl cellulose, or alkali metal salts thereof. Na, K, or Li may be used as the alkali metal.

The dry binder is a polymer material capable of being fiberized and may be, for example, polytetrafluoroethylene, polyvinylidene fluoride, a polyvinylidene fluoride-hexafluoropropylene copolymer, polyethylene oxide, or a combination thereof.

The separator may be disposed between the first electrode and the second electrode. The separator may function to prevent a short circuit of the first electrode and the second electrode while allowing lithium ions to move between the first electrode and the second electrode. The separator may be disposed to completely cover a surface region of the electrode assembly. Accordingly, the separator may prevent the first electrode and the second electrode from being directly exposed to the outside of the electrode assembly.

As the separator, polyethylene, polypropylene, polyvinylidene fluoride, or multilayer films of two or more layers thereof may be used and mixed multilayer films such as a polyethylene/polypropylene two-layer separator, a polyethylene/polypropylene/polyethylene three-layer separator, a polypropylene/polyethylene/polypropylene three-layer separator, etc. may be used.

The separator may include a porous substrate and a coating layer containing an organic material, an inorganic material, or a combination thereof located on one or both surfaces of the porous substrate.

The porous substrate may be a polymer film formed of any one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, Teflon, and polytetrafluoroethylene, or a copolymer or mixture of two or more thereof.

The organic material may include a polyvinylidene fluoride-based polymer or a (meth) acryl-based polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. The organic material and the inorganic material may be present as a mixture in a single coating layer or may be present in a form in which a coating layer including an organic material and a coating layer including an inorganic material are stacked.

The top plate 230 may be disposed or coupled to an upper side of the module case 210. The top plate 230, which is a member having an overall plate shape, may be disposed on an upper side of the plurality of secondary batteries 220 while covering the upper portion of the plurality of secondary batteries 220, and/or coupled to the module case 210. For example, the top plate 230 may be coupled to upper ends of the end plate 212 and the side plates 213 of the module case 210 by coupling methods such as bolting, fitting, welding, or the like.

The electrode terminals 222 of the secondary battery 220, that is, the positive electrode terminal and the negative electrode terminal, may be exposed on the upper side of the top plate 230. In addition, a bus bar 235 may be connected to the electrode terminals 222 to connect a plurality of secondary batteries 220 in series, parallel, or series-parallel forms.

The top plate 230 may be provided with a duct 232 having a planar shape such as a square, oval, or circle. The duct 232 may be provided at a position corresponding to the vent 224 provided on the cap plate of the secondary battery 220. A plurality of ducts 232 may be arranged in one direction of the top plate 230, for example, the X-axis direction in which the secondary batteries 220 are arranged. The number of ducts 232 provided on the top plate 230 may correspond to the number of secondary batteries 220.

The duct 232 may function as a passage for guiding and discharging high-temperature gas through the vent 224 upward. To this end, the duct 232 may have a structure in which a through hole having a planar shape such as a square, oval, or circle is defined by a sidewall structure. As indicated by the arrows in FIGS. 6 and 7, the gas discharged from the vent 224 may move upward along the through hole defined by the sidewall of the duct 232.

The fire extinguishing sheet 240 may be disposed between the top plate 230 and the upper cover 250. The fire extinguishing sheet 240 may be formed as at least one member extending in one direction of the top plate 230, for example, in a longitudinal direction (X-axis direction). The fire extinguishing sheet 240 contains a fire extinguishing agent therein, and may discharge the fire extinguishing agent at high temperatures to extinguish thermal runaway or prevent its spread to adjacent secondary batteries 220 even when the thermal runaway occurs in the secondary battery 220.

The fire extinguishing sheet 240 may be provided with a plurality of through holes, i.e., second openings 244. The second opening 244 may be formed at a position corresponding to the duct 232. The size of the second opening 244 may be greater than the opening defined by the sidewall of the duct 232. Accordingly, the fire extinguishing sheet 240 may be disposed on the upper side of the top plate 230 such that the second opening 244 is aligned with the duct 232 of the top plate 230. The fire extinguishing sheet 240 may be coupled to the top plate 230 at a position spaced a predetermined distance apart from the top plate 230 and/or to a lower surface of the upper cover 250. The configuration and operation of the fire extinguishing sheet 240 are described herein.

The upper cover 250 may be disposed above the top plate 230 with the fire extinguishing sheet 240 interposed therebetween. The upper cover 250 may be coupled to the top plate 230 or the module case 210, depending on the implementation. The upper cover 250 may cover the top plate 230 and the bus bar 235. In addition, the upper cover 250 may also cover the fire extinguishing sheet 240 disposed on its lower side, thereby protecting them from impacts applied to the upper surface of the upper cover 250.

The upper cover 250 may be provided with a plurality of through holes, i.e., first openings 252. Like the ducts 232 and the second openings 244, the plurality of first openings 252 may be arranged in one direction of the upper cover 250, for example, the X-axis direction. The plurality of first openings 252 may be provided at positions corresponding to each of the ducts 232 of the top plate 230 and the second openings 244 of the fire extinguishing sheet 240, so as to function as exhaust holes. Accordingly, the gas discharged from the vent 224 of the secondary battery 220 may be discharged to the outside of the energy storage module 20 through the duct 232 of the top plate 230, the second opening 244 of the fire extinguishing sheet 240, and the first opening 252 of the upper cover 250.

The first opening 252, like the second opening 244, may be in the form of a single hole. Alternatively, as illustrated in FIG. 2, the first openings 252 may be provided in the form of a plurality of holes spaced apart from one another. This may prevent a user's hand from coming into contact with an internal structure of the upper cover 250.

The upper cover 250 may further include a protrusion 254 formed around the first opening 252. The protrusion 254 may protrude downward (in the −Z-axis direction) from a lower surface of the upper cover 250, and may be coupled to an outer side of the duct 232 by passing through the second opening 244 of the fire extinguishing sheet 240. Accordingly, in the XY plane, a planar shape of the protrusion 254 may correspond to a planar shape of the duct 232. As illustrated in FIGS. 6 and 7, gas moving upward along the duct 232 may be discharged to the outside of the secondary battery 220 through the second opening 244 of the fire extinguishing sheet 240 and the second opening 244 of the upper cover 250.

Next, the configuration and operation of the fire extinguishing sheet 240 of the energy storage module 20 according to embodiments of the present disclosure will be described in more detail.

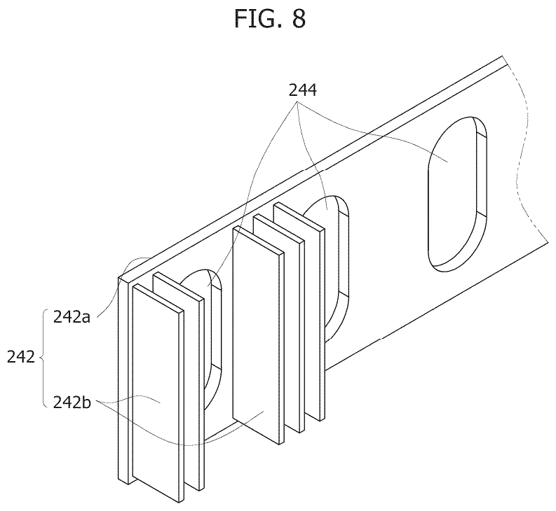

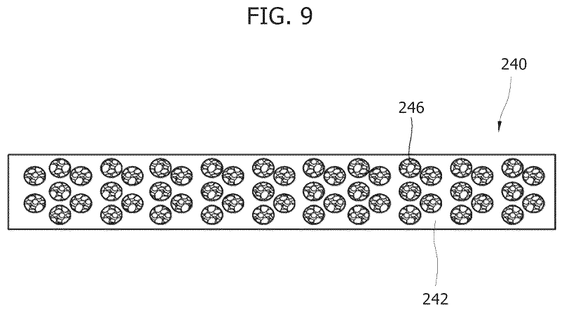

FIG. 8 is a perspective view illustrating a fire extinguishing sheet according to embodiments. FIG. 9 is a view schematically illustrating a configuration of the fire extinguishing sheet in FIG. 8.

Referring to FIGS. 6 to 8, the fire extinguishing sheet 240 may include a flat plate portion 242a and a protrusion 242b. The flat plate portion 242a and the protrusion 242b may be integrally formed as a single structure. However, the present disclosure is not limited thereto, and the flat plate portion 242a and the protrusion 242b may be bonded using a predetermined adhesive and/or coupled through a method such as a fitting, press-fitting, or the like.

However, in FIG. 9, the fire extinguishing sheet 240 is illustrated in a flat form for the purpose of understanding its structure. As illustrated in FIG. 9, the fire extinguishing sheet 240 in FIG. 8, which includes the flat plate portion 242a and the protrusion 242b, may have a configuration in which a plurality of capsules 246 containing the fire extinguishing agent are dispersed in a base member 242. Accordingly, the fire extinguishing agent may be encapsulated in the form of a pouch, mixed with a material forming the base member 242, and then integrally formed into the fire extinguishing sheet 240 by a casting method using a mold corresponding to the shape of the fire extinguishing sheet 240. The base member 242 may be formed of an epoxy material, such as polyurea or polyurethane.

The fire extinguishing sheet 240 may operate in response to heat at a high temperature, for example, at temperatures of about 400 °C or higher. For example, when thermal runaway occurs in the secondary battery 220 and a high-temperature inert gas is discharged through the vent 224, direct or indirect contact between the high-temperature gas and the fire extinguishing sheet 240 may cause the base member 242 to rupture, thereby allowing the fire extinguishing agent contained in the capsule 246 to be discharged. In this case, since the upper side of the fire extinguishing sheet 240 is blocked by the upper cover 250, the fire extinguishing agent may be discharged in a direction toward the lower surface of the upper cover 250.

The flat plate portion 242a of the fire extinguishing sheet 240 may be a plate-shaped structure in which a plurality of second openings 244 are arranged. The flat plate portion 242a may have a predetermined width and may extend in the X-axis direction (see FIG. 4), As described herein, the plurality of second openings 244, similar to the plurality of ducts 232 provided in the top plate 230, may be arranged in an extension direction of the flat plate portion 242a at positions corresponding to the vents 224 of the secondary battery 220.

Also, the protrusion 242b may protrude from the flat plate portion 242a in a direction toward the top plate 230 (i.e., a downward direction in FIG. 6 or 7). That is, the protrusion 242b may be a structure having a predetermined shape that protrudes into the empty space between the flat plate portion 242a and the top plate 230. In this way, by further including the protrusion 242b along with the flat plate portion 242a, the size (volume) of the fire extinguishing sheet 240 may be increased by the size (volume) of the protrusion 242b. Accordingly, the amount of the capsule 246, i.e., the fire extinguishing agent, included in the fire extinguishing sheet 240 may be increased in proportion to the volume of the protrusion 242b, thereby improving the fire extinguishing performance (capacity) of the energy storage module 20 including the same.

The protrusion 242b may be provided at a position of the flat plate portion 242a around the second opening 244. As described herein, since the second opening 244 in the flat plate portion 242a is disposed at a position corresponding to the vent 224 of the secondary battery 220, the protrusion 242b disposed around the second opening 244 may also be disposed adjacent to the vent 224. Accordingly, when high-temperature gas is discharged through the vent 224, the protrusion 242b may also come into direct contact with the high-temperature gas or may be exposed to a high-temperature environment. Therefore, when thermal runaway occurs in the secondary battery 220 located below, the fire extinguishing sheet 240 including the protrusion 242b may more rapidly discharge the fire extinguishing agent contained in the capsule 246.

The protrusion 242b disposed on the flat plate portion 242a between adjacent second openings 244 may be a single integrated structure. In this case, the protrusion 242b may be a structure having a predetermined shape, such as a rectangular parallelepiped, with a size corresponding to the empty space between the second openings 244. That is, the protrusion 242b disposed on the flat plate portion 242a between the adjacent second openings 244 may have an overall rectangular parallelepiped shape.

Alternatively, the protrusion 242b, as illustrated in FIG. 8, may be a structure including a plurality (three in FIG. 8) of plate-shaped structures having a relatively small volume, which are disposed spaced apart from one another. Accordingly, compared to the form in which the protrusion 242b is formed as a single structure, the overall surface area of the protrusion 242b may be increased. In addition, the protrusion 242b having a relatively large surface area increases the size of a region that is in direct contact with high-temperature gas or is exposed to a high-temperature environment, and thus the amount of the fire extinguishing agent discharged at one time may increase. Accordingly, the performance of the fire extinguishing sheet 240 may be further enhanced.

When the flat plate portion 242a has a predetermined width and extends in the X-axis direction (see FIG. 4), the plurality of protrusions 242b may have a plate shape that extends in the Y-axis direction (see FIG. 4) with a predetermined thickness. In addition, the plurality of plate-shaped protrusions 242b may be arranged to be spaced apart from one another in the X-axis direction. Accordingly, not only can a large number of protrusions 242b be disposed on the flat plate portion 242a between the adjacent second openings 244, but the surface area of each protrusion 242b can also be maximized, thereby further enhancing the performance of the fire extinguishing sheet 240.

According to the present disclosure, when thermal runaway occurs in any one of a plurality of secondary batteries constituting an energy storage module, a large amount of fire extinguishing agent can be initially discharged, thereby quickly and effectively suppressing or preventing the spread of fire to the surrounding secondary batteries.

However, the effects obtainable through the present disclosure are not limited to the effects described herein, and other technical effects not mentioned will be clearly understood by those skilled in the art from the description of the disclosure described herein.

Although the present disclosure has been described herein by limited embodiments and drawings, the present disclosure is not limited thereto, and various modifications and variations may be made by those skilled in the art within the spirit of the present disclosure and the equivalent scope of the claims to be described herein.

What is claimed is:

1. An energy storage module comprising:
a plurality of secondary batteries;
a module case that accommodates the plurality of secondary batteries therein and has an open upper side;
a top plate coupled to the open upper side of the module case and provided with a duct at a position corresponding to a vent of the secondary battery;
an upper cover coupled to an upper side of the top plate and provided with a first opening at a position corresponding to the duct; and
a fire extinguishing sheet, which is disposed between the top plate and the upper cover and provided with a second opening at a position corresponding to the duct, and accommodates a fire extinguishing agent therein, wherein the fire extinguishing sheet includes a flat plate portion provided with a plurality of second openings and a protrusion protruding from the flat plate portion in a direction toward the top plate.

2. The energy storage module of claim 1, wherein the protrusion protrudes from the flat plate portion around the second opening.

3. The energy storage module of claim 2, wherein a plurality of protrusions are spaced apart from one another and disposed between adjacent second openings.

4. The energy storage module of claim 3, wherein:
the flat plate portion has a shape extending in a first direction, which is an arrangement direction of the secondary battery, and
the protrusion has a plate shape extending in a second direction that intersects the first direction.

5. The energy storage module of claim 4, wherein the plurality of protrusions disposed between the adjacent second openings are arranged substantially in the first direction.

6. The energy storage module of claim 1, wherein the flat plate portion and the protrusion are integrally formed.

7. The energy storage module of claim 6, wherein in the fire extinguishing sheet, a plurality of capsules containing the fire extinguishing agent are dispersed in a base member made of polyurea or polyurethane.

8. An energy saving system including a rack on which a plurality of energy storage modules are mounted,
wherein the energy storage module comprises:
a plurality of secondary batteries;
a module case that accommodates the plurality of secondary batteries therein and has an open upper side;
a top plate coupled to the open upper side of the module case and provided with a duct at a position corresponding to a vent of the secondary battery;
an upper cover coupled to an upper side of the top plate and provided with a first opening at a position corresponding to the duct; and
a fire extinguishing sheet, which is disposed between the top plate and the upper cover and provided with a second opening at a position corresponding to the duct, and accommodates a fire extinguishing agent therein,
wherein the fire extinguishing sheet includes a flat plate portion provided with a plurality of second openings and a protrusion protruding from the flat plate portion in a direction toward the top plate.

9. The energy saving system of claim 8, wherein the protrusion protrudes from the flat plate portion around the second opening.

10. The energy saving system of claim 9, wherein a plurality of protrusions are spaced apart from one another and disposed between adjacent second openings.

11. The energy saving system of claim 10, wherein:
the flat plate portion has a shape extending in a first direction, which is an arrangement direction of the secondary battery, and
the protrusion has a plate shape extending in a second direction that intersects the first direction.

12. The energy saving system of claim 11, wherein the plurality of protrusions disposed between the adjacent second openings are arranged substantially in the first direction,

13. The energy saving system of claim 8, wherein the flat plate portion and the protrusion are integrally formed.

14. The energy saving system of claim 13, wherein in the fire extinguishing sheet, a plurality of capsules containing the fire extinguishing agent are dispersed in a base member made of polyurea or polyurethane.
